(19) United States
(12) Patent Application Publication
(10) Pub. No.: US 2026/0264287 A1
(43) Pub. Date: Sep. 10, 2026

(54) METHOD AND APPARATUS FOR DRY MANUFACTURING RIGID CELLULOSE PRODUCTS

(71) Applicants: CHANEL PARFUMS BEAUTÉ, Neuilly-sur-Seine (FR); Yangi AB, Varberg (SE)

(72) Inventors: Maria Englander, Lindome (SE); Linnea JOHNSSON, Åskloster (SE); Nicolas MATHIEU, Neuilly-sur-Seine (FR); Anne Lapierre, Neuilly-sur-Seine (FR)

(73) Assignees: CHANEL PARFUMS BEAUTÉ, Neuilly-sur-Seine (FR); Yangi AB, Varberg (SE)

(21) Appl. No.: 19/491,427

(22) PCT Filed: Jun. 10, 2024
(86) PCT No.: PCT/EP2024/065856

§ 371 Date: Dec. 9, 2025

(30) Foreign Application Priority Data
Jun. 12, 2023 (EP) 23178598.1

(51) Int. Cl. B27N 3/20; B27N 3/12; B27N 3/18; B27N 5/02

(52) U.S. Cl. CPC B27N 3/203; B27N 3/12; B27N 3/18; B27N 5/02

(57) ABSTRACT

A method for dry manufacturing rigid cellulose products having non-flat general shape and an internal cavity. The method includes the steps of, pressing at least one product area of the first cellulose blank segment into a final rigid non-flat shape, keeping a rim area of the first cellulose blank segment in a non-final non-rigid shape, pressing at least one product area of the second cellulose blank segment into a final rigid shape, placing the rim area of the first cellulose blank segment in contact with a rim area of the second cellulose blank segment, and joining the rim areas of the first and second cellulose blank segments into a homogenous final rigid rim, thereby obtaining the rigid cellulose product having non-flat general shape wherein the internal cavity is delimited by the pressed product areas of the first and second cellulose blank segments.

### TECHNICAL FIELD OF THE INVENTION

The present invention relates in general to the field of method and apparatus for dry manufacturing of rigid cellulose products having non-flat general shape and an internal cavity. The cellulose products may be used for packaging, storing, transporting and/or displaying other products such as electronics, tools, jewelry, food, dairy products, cosmetics, etc., and/or may be used as single/multiple use disposable articles. The present invention also relates to such rigid cellulose product.

### BACKGROUND OF THE INVENTION

There are many situations where it is desirable to provide two-dimensional (2D) or three-dimensional (3D) shaped objects made of sustainable materials, such as biomaterials, instead of plastic/polymer materials. A biomaterial commonly used for packaging is wet moulded pulp based on cellulose fibres. Such wet moulded pulp has the advantage of being considered as a sustainable packaging material, since it is produced from biomaterials and can be recycled after use. Wet moulded pulp comprises more or less only water and separated cellulose fibers, and consequently, wet moulded pulp has been popular to use for primary packaging applications (packaging next to the article) and secondary packaging applications (assembly of such primary packages).

However, a common disadvantage with all wet-forming techniques is the need for large amounts of water during the preparations of the cellulose pulp and the need for drying during the manufacturing/moulding of the product, which is a time and energy consuming step leading to low production speed and substantial high investment cost in machines and tooling. Meaning that the wet-forming techniques are not feasible to replace fossil-based alternatives neither in small nor large scale production of rigid cellulose products. Thereto, the aesthetical and mechanical properties of a wet-moulded cellulose product are hard to control with desirable precision, due to un-uniform cellulose pulp and due to the wet moulding manufacturing technique per se.

Therefore many actors/companies, starting a few decades ago, have changed their focus and investments towards dry-forming techniques wherein rigid cellulose products are manufactured from separated cellulose fibres that are introduced into a product forming unit in the shape of a cellulose blank/web, wherein the cellulose blank is formed into the shape of the intended cellulose product and wherein the cellulose fibres are bonded to each other using heat and pressure. The dry-forming techniques comprises different steps of generating an air-laid cellulose blank, that is fed into a product forming unit.

The technical field of dry manufacturing rigid cellulose products having non-flat general shape, such as trays, lids, or the like, i.e. wherein the forming/pressing is performed in one step using a forming tool having a male mould part and a female mould part configured to cooperate with each other, is well known. However, the sub-technical field of dry manufacturing rigid cellulose products having non-flat general shape and an internal cavity, such as bottles or the like, is still exposed to challenges. Such products are characterized in that both the inside and the outside of the cellulose product need to be accessed during the forming/moulding using heat and pressure, in order to obtain the required rigidity and characteristics of the cellulose product. EP 3976615 disclose use of a forming tool having two cooperating female mould parts, wherein a pressure fluid is introduced into the mould cavity in order to form/press the tube-shaped cellulose blank outwards/towards the stationary female mould parts. This technique has its obvious drawbacks relating to the use of pressure fluid during the pressing/forming step which also requires the use of a liquid impermeable film separating the pressure fluid from the cellulose blank. Thereto, this technique cannot generate rigid cellulose products that are completely closed and empty inside.

An alternative technique to dry manufacture rigid cellulose products having non-flat general shale and an internal cavity, is to separately manufacture each of two product halves according to known technique for manufacturing rigid cellulose products not having an internal cavity. Thereafter these two product halves are connected to each other using glue or another adhesive. However, when using glue or other adhesive it is a major risk that the cellulose product is miscoloured/stained, thereto the manufacturing per se is made more complex when using such chemicals in the production since it can be harmful for the personal and the environment and adds extra production steps to the manufacturing that are expensive and time consuming (application of glue and drying/curing of the glue), and thereto the glue/adhesive adds extra cost. The glue/adhesive may also have negative effect on the production equipment in the downstream production steps and to the articles/products that the rigid cellulose products are intended to be used together with.

There is a need in the art for a reliable, cheap and unharmful dry-forming technique/process for dry manufacturing rigid cellulose products having non-flat general shape and an internal cavity.

### OBJECT OF THE INVENTION

The present invention aims at obviating the aforementioned and other disadvantages and failings of previously known methods and apparatus for dry manufacturing rigid cellulose products, and at providing an improved method and apparatus for dry manufacturing rigid cellulose products having non-flat general shape and an internal cavity.

A primary object of the present invention is to provide an improved method and apparatus for dry forming/manufacturing rigid cellulose products having non-flat general shape and an internal cavity, wherein the environmental benefits as well as time and energy saving benefits of conventional dry-forming techniques are maintained. It is another object of the present invention to provide an improved method and apparatus for dry forming/manufacturing rigid cellulose products having non-flat general shape and an internal cavity, wherein the process is free from glue/adhesive. It is another object of the present invention to provide an improved method and apparatus for dry forming/manufacturing rigid cellulose products having non-flat general shape and an internal cavity, wherein the rigid cellulose product may comprise cellulose fibers only.

### SUMMARY OF THE INVENTION

According to the invention at least the primary object is attained by means of the initially defined method and apparatus having the features defined in the independent claims. Preferred embodiments of the present invention are further defined in the dependent claims.

According to a first aspect of the present invention, there is provided a method for dry manufacturing rigid cellulose products having non-flat general shape and an internal cavity. The method comprises the steps of:
providing an air-laid first cellulose blank segment, wherein the first cellulose blank segment comprises at least one product area and a rim area located adjacent and at least partly surrounding said at least one product area,
pressing the at least one product area of the first cellulose blank segment into a final rigid non-flat shape by applying a predetermined first pressure P1, and keeping the rim area of the first cellulose blank segment in a non-final non-rigid shape,
providing a second cellulose blank segment, wherein the second cellulose blank segment comprises at least one product area and a rim area located adjacent and at least partly surrounding the at least one product area,
pressing the at least one product area of the second cellulose blank segment into a final rigid shape by applying a predetermined second pressure P2,
   thereafter
placing the rim area of the first cellulose blank segment in contact with the rim area of the second cellulose blank segment, and placing the at least one product area of the first cellulose blank segment in overlapping configuration with the at least one product area of the second cellulose blank segment, and
joining together the rim area of the first cellulose blank segment and the rim area of the second cellulose blank segment into a homogeneous final rigid rim by applying a predetermined rim pressure P-rim, thereby obtaining the rigid cellulose product having non-flat general shape wherein the internal cavity is delimited by the pressed product area of the first cellulose blank segment and by the pressed product area of the second cellulose blank segment.

According to a second aspect of the present invention, there is provided an apparatus for dry manufacturing rigid cellulose products having essentially non-flat general shape and an internal cavity from an air-laid first cellulose blank segment and a second cellulose blank segment, wherein the first cellulose blank segment comprises at least one product area and a rim area located adjacent and at least partly surrounding said at least one product area, and wherein the second cellulose blank segment comprises at least one product area and a rim area located adjacent and at least partly surrounding the at least one product area. The apparatus comprises:
a first moulding tool having a first mould part and a second mould part configured to press the at least one product area of the first cellulose blank segment into a final rigid non-flat shape by applying a predetermined first pressure P1, and to keep the rim area of the first cellulose blank segment in a non-final non-rigid shape,
a second moulding tool having a first mould part and a second mould part configured to press the at least one product area of the second cellulose blank segment into a final rigid shape by applying a predetermined second pressure P2, and
a third moulding tool located downstream and having a first mould part and a second mould part configured to join together the rim area of the first cellulose blank segment and the rim area of the second cellulose blank segment into a homogeneous final rigid rim by applying a predetermined rim pressure P-rim, thereby obtaining the rigid cellulose product having non-flat general shape and an internal cavity.

Thus, the present invention is based on the insight of utilizing the same physical properties when bonding/joining the rim areas of the pre-pressed first cellulose blank segment and the pre-pressed second cellulose blank segment, as when pressing the product areas of the cellulose blank segments. In other words, the rim area of at least one of the two cellulose blank segments is un-compressed or only partially compressed when the corresponding product area is pressed, entailing that the cellulose fibers in the boundary layer of the non-rigid rim area will create internal bindings (hydrogen bindings) with cellulose fibers from both rim areas of the two cellulose blank segments during the joining/pressing step, whereby a homogenous final rigid rim is provided.

The present invention provides the advantage that all surfaces of the rigid cellulose product, outer surfaces as well as inner surfaces facing the internal cavity, are pressed and thereby mechanically stable/robust and able to withstand reasonable wear, without using an internal mould core.

Another essential advantage of the present invention is that the method and apparatus entails that no glue/adhesive need to be used when joining/bonding the rigid cellulose product having an internal cavity. It is also an advantage that a rigid cellulose product having an internal cavity saves a great amount of material in relation to a massive/compact rigid cellulose product, i.e. a decreased impact on the environment.

According to various example embodiments of the present invention the following step of said method:
pressing the at least one product area of the second cellulose blank segment into a final rigid shape by applying a predetermined second pressure P2,
   also comprises the step of:
keeping the rim area of the second cellulose blank segment in a non-final non-rigid shape, or
pressing the rim area of the second cellulose blank segment into a rigid shape by applying the predetermined second pressure P2.

Thus, the second cellulose blank segment may be treated/handled like the first cellulose blank segment during the pre-pressing, i.e. pressing the product area, or the entire second cellulose blank segment may be pressed during the pre-pressing thereof. Thus, according the first alternative the second cellulose blank segment after the pre-pressing has a pressed product area and an un-compressed or partially compressed rim area, and according to the second alternative both the product area and the rim area of the second cellulose blank segment are pressed. The un-compressed or partially compressed rim area of the first cellulose blank segment will adhere to the rim area of the second cellulose blank segment in both embodiments/alternatives during the joining/bonding of the final rigid rim.

According to various example embodiments of the present invention the following step of said method:
keeping the rim area of the first cellulose blank segment in a non-final non-rigid shape, comprises the step of:
partially compressing the rim area of the first cellulose blank segment into a non-final non-rigid shape by applying a predetermined third pressure P3, wherein P3<P1.

The advantage of this step of partially compressing the rim area of the first cellulose blank segment is that the pre-pressed first cellulose blank segment is easier to handle/move without having large amounts of cellulose fibres releasing, or running the risk of having the rim area separating from the product area of the pre-pressed cellulose blank segment.

According to various example embodiments of the present invention the rim pressure P-rim>P1. Since the final rigid rim is constituted by two rim areas joined/bonded together, the surface weight of the final rigid rim is greater than at the product area of the first cellulose blank segment, and by using a higher pressure when joining/bonding the rim areas it is assured that the final rigid rim is homogenous and rigid.

According to various example embodiments of the present invention, the rim area of the first cellulose blank segment is circumferential and surrounds said at least one product area of the first cellulose blank segment, and the rim area of the second cellulose blank segment is circumferential and surrounds said at least one product area of the second cellulose blank segment, whereby the final rigid rim of the rigid cellulose product having non-flat general shape is circumferential.

Thereby, the internal cavity is fully closed and such rigid cellulose products having non-flat general shape are ideal to be used to fill out empty volumes in a box/carton in order to protect articles transported in the box/carton. Such rigid cellulose products may be provided with high volume/weight ratio and be rigid during use and still easily recyclable. Such rigid cellulose products having a closed internal cavity may also be used to transport articles inside, such as a toothbrush, a nail clipper, etc. Thus, the article is placed in the internal cavity before the rim areas are joined/bonded, and the article is protected during transport and in the store, and still easily accessible and the entire package is easily recyclable.

According to various example embodiments of the present invention, the method before the step of:
placing the rim area of the first cellulose blank segment in contact with the rim area of the second cellulose blank segment,
   comprises the step of:
applying a liquid composition comprising cellulose to at least one of the rim area of the first cellulose blank segment and the rim area of the second cellulose blank segment.

The liquid composition comprising cellulose are preferably constituted by separated cellulose fibres that are wet/damp using water. The advantage is to assure that the joining/bonding of the rim areas generates a homogenous and rigid final rigid rim. By applying extra cellulose and water, also rim areas that during handling of the pre-pressed cellulose blank segments may have lost cellulose fibres and/or may have dried will be adequately joined/bonded into a homogenous final rigid rim.

According to a third aspect of the present invention, there is also provided a rigid cellulose product manufactured by said inventive method, wherein the rigid cellulose product has an internal cavity delimited by a pressed product area of a first cellulose blank segment and by a pressed product area of the second cellulose blank segment, wherein a rim area of the first cellulose blank segment that is located adjacent and at least partly surrounds said product area of the first cellulose blank segment, and a rim area of the second cellulose blank segment that is located adjacent and at least partly surrounds said product area of the second cellulose blank segment, are joined at a homogeneous final rigid rim.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic illustration of a production line or apparatus for dry manufacturing rigid cellulose products,

FIG. 2 is a schematic illustration of a cellulose blank comprising a first cellulose blank segment,

FIG. 3 is a schematic illustration of a cellulose blank comprising a first cellulose blank segment and a second cellulose blank segment, wherein each cellulose blank segment comprises a plurality of product areas,

FIG. 4 is a schematic perspective view of a box/carton filled with inventive rigid cellulose products,

FIG. 5 is a schematic illustration of a first/second moulding tool, wherein a cellulose blank according to FIG. 2 is loaded therein,

FIG. 6 is a schematic illustration of the moulding tool according to FIG. 5, wherein the product area of the cellulose blank is pressed into final rigid non-flat shape and the rim area is only partially compressed,

FIG. 7 is a schematic illustration of the moulding tool according to FIGS. 5 and 6, wherein the cellulose blank is released,

FIG. 8 is a schematic illustration of a third moulding tool, wherein two pre-pressed cellulose blanks according to FIG. 7 are loaded therein,

FIG. 9 is a schematic illustration of the third moulding tool according to FIG. 8, wherein the rim area of the first cellulose blank segment and the rim area of the second cellulose blank segment are abutting each other,

FIG. 10 is a schematic illustration of the third moulding tool according to FIGS. 8 and 9, wherein the rim areas are joined/bonded into a final rigid rim,

FIG. 11 is a schematic illustration of the third moulding tool according to FIGS. 8-10, wherein the rigid cellulose product is released,

FIG. 12 is a schematic illustration of a combined first/second moulding tool, wherein a cellulose blank according to FIG. 3 is loaded therein,

FIG. 13 is a schematic illustration of the combined first/second moulding tool according to FIG. 12, wherein the product areas of the cellulose blank are pressed into final rigid non-flat shape and the rim areas are only partially compressed,

FIG. 14 is a schematic illustration of the combined first/second moulding tool according to FIGS. 12 and 13, wherein the cellulose blank is released,

FIG. 15 is a schematic illustration of a third moulding tool, wherein a pre-pressed cellulose blank according to FIG. 14 having a first cellulose blank segment and a second cellulose blank segment is loaded therein in folded configuration,

FIG. 16 is a schematic illustration of a rigid cellulose product according to a first example embodiment, wherein the final first cellulose blank segment and the final second cellulose blank segment are identical and have non-flat general shape,

FIG. 17 is a schematic illustration of a rigid cellulose product according to a second example embodiment, wherein the final first cellulose blank segment has non-flat general shape and the final second cellulose blank segment is flat,

FIG. 18 is a schematic illustration of a rigid cellulose product according to a third example embodiment, wherein the final first cellulose blank segment has one non-flat general shape and the final second cellulose blank segment has another non-flat general shape, wherein both are convex towards the outside,

FIG. 19 is a schematic illustration of a rigid cellulose product according to a fourth example embodiment, wherein the final first cellulose blank segment has one non-flat general shape and the final second cellulose blank segment has another non-flat general shape, wherein the final first cellulose blank segment is convex towards the outside and the final second cellulose blank segment is concave towards the outside,

FIG. 20 is a schematic cross sectional side view of a rigid cellulose product in the shape of an open pouch, wherein the internal cavity is open to the outside,

FIG. 21 is a schematic partial cross-sectional view from above of the rigid cellulose product according to FIG. 20,

FIG. 22 is a schematic cross-sectional side view of a rigid cellulose product in the shape of an openable pouch, wherein the internal cavity is in closed state,

FIG. 23 is a schematic partial cross-sectional view from above of the rigid cellulose product according to FIG. 22, and

FIG. 24 is a schematic end view of the rigid cellulose product according to FIGS. 22 and 23, wherein the internal cavity is opened to the outside.

### DETAILED DESCRIPTION OF PREFERRED EMBODIMENTS OF THE INVENTION

As used herein, the term “air/dry moulding/forming or air/dry laying/laid” means a well-known method according to which separated cellulose fibres are formed into a cellulose blank/sheet.

In air-laying technique, small/short fibres having a normal length in the range of 0.5 to 70 mm, for instance 1 to 50 mm, are separated and captured by an air stream/flow, and then laid on/applied to a forming mesh/surface, usually using a low pressure at the other side of the mesh/surface. The terms “air/dry laying” and “air/dry moulding” are used interchangeably herein. The cellulose fibre carrying air flow may be generated by suitable device located upstream and/or downstream the forming mesh/surface.

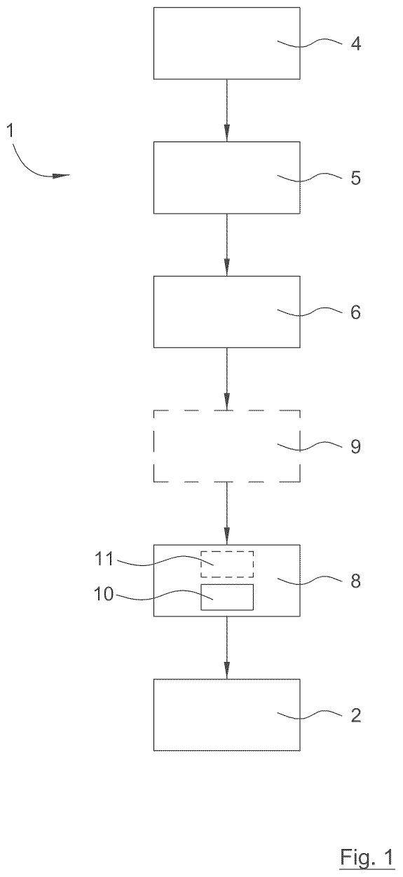

Reference is initially made to FIGS. 1-4, wherein FIG. 1 disclose a schematic illustration of a generic production line/apparatus for dry manufacturing rigid cellulose products, generally designated 1. The production line 1 is configured for manufacturing rigid cellulose products, generally designated 2, having essentially non-flat general shape from separated cellulose fibres. Such a production line 1 may be arranged and set-up according to different well-known ways.

FIG. 4 disclose a box/carton 3 that is filled with inventive rigid cellulose products 2, in order to protect a transported article (not disclosed).

Cellulose raw material 4 is provided to the production line, and is fed to a separating/disintegrating unit 5 in order to obtain individualized/separated cellulose fibres. The separated cellulose fibres are thereafter transported by an air stream/flow to a dispenser of a cellulose blank/sheet forming unit 6. The cellulose fibres are laid by the dispenser on a moving or stationary perforated surface of the cellulose blank forming unit 6. The cellulose fibre carrying air flow may be generated by suitable device located upstream and/or downstream the perforated surface. Thereafter the generated/manufactured cellulose blank, generally designated 7, is transported to a product forming unit 8, whereby rigid cellulose products 2 are formed and discharged from the product forming unit 8. Thus, the air-laid cellulose blank is manufactured by means of the cellulose blank forming unit 6 and provided to the downstream station of the production line.

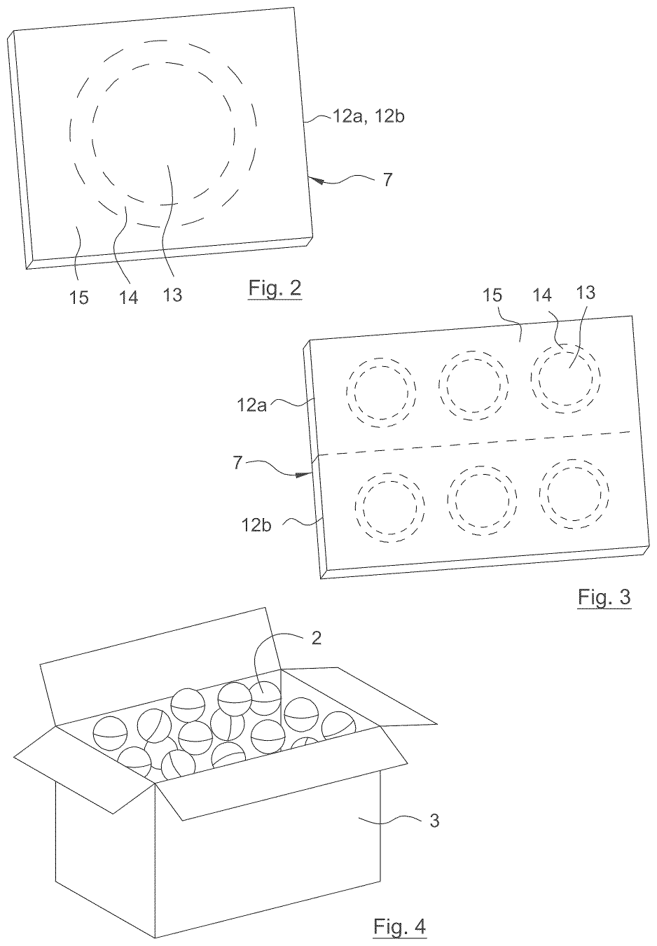

FIGS. 2 and 3 disclose two different types of cellulose blanks 7, which are examples of discreate cellulose blanks. The cellulose blank forming unit 6 may be configured to generate/manufacture a continuous cellulose blank 7 and/or discontinuous/discrete cellulose blanks 7. Preferably discontinuous/discrete cellulose blanks 7 are fed into the product forming unit 8.

The cellulose raw material 4 may be in the form of reeled pulp or paper, bale of cellulose pulp, paper, etc. and/or sheets of paper, cellulose pulp, etc. In case said cellulose raw material 4 is in the form of sheets and/or reeled pulp or paper, it can be fed directly into the separating unit 5. However, in case said cellulose raw material 4 is in the form of a bale or compact stacks of sheets, etc. one or more shredders and/or one or more additional separating/disintegrating units 5 may be necessary to be used for separating and dosing said cellulose raw material 4 from said bale or sheets in smaller quantities. The shredder(s) prepare cellulose raw material 4 to be accepted by said separating unit 5. The separating unit 5 disintegrates the cellulose raw material 4 into separated cellulose fibres. Said one or plurality of shredder(s) are arranged before said one or a plurality of separating unit(s) 5, so that an output of one of said shredder is connected to an input of one of said separating units 5. The shredders may be arranged in parallel to each other or in series with each other, and the disintegrating units 5 may be arranged in parallel to each other or in series with each other. The shredders and the disintegrating units 5 together constitute a cellulose fibre separating unit, arranged upstream the cellulose blank forming unit 6.

Said cellulose raw material 4 may be constituted by virgin cellulose fibres and/or recycled cellulose fibres and may originate from wood pulps such as kraft pulp, sulphite pulp, mechanical pulp, thermomechanical pulp (TMP), chemical treated mechanical pulp, chemi-thermomechanical pulp (CTMP), and/or from non-wood pulps such as bagasse, bamboo, abaca, hemp, flax, cotton.

The separating unit 5 may according to various embodiments be constituted by a hammer mill. In said separating unit 5 the cellulose raw material is separated into fibres having a normal length in the range of 0.5-70 mm. The length of said fibres may be customized by adjusting the internal properties of the separating unit 5 and/or by choosing a different separating unit 5 and/or choosing different cellulose raw material. The fibre length for wood pulp is according to various embodiments in the range 0.5-4 mm, preferably in the range 1.7-3.6 mm. According to various embodiments the fibre length for non-wood pulp is in the range 0.5-70 mm.

The production line 1 may comprise a pre-compression and/or imprinting unit 9, located downstream the cellulose blank forming unit 6 and upstream the product forming unit 8. In the pre-compression and/or imprinting unit 9, an air-laid fluffy cellulose blank 7 having a first thickness may be compressed into a cellulose blank 7 having a second thickness, wherein said second thickness is thinner than said first thickness, and/or may be provided with an imprinting pattern. During the pre-compression/imprinting the cellulose blank is made more coherent and easier to handle, since the pre-compression/imprinting generates internal bindings between individual cellulose fibres preventing mutual separation of the cellulose fibres.

The product forming unit 8 comprises a press unit 10, and may optionally comprise a pre-heating unit 11 arranged upstream the press unit 10. According to various example embodiments said cellulose blank 7 may be heated to an elevated temperature before being fed into the press unit 10 of the product forming unit 8. In such embodiment(s) where the cellulose blank 7 is preheated before being fed into the press unit 10, said press unit 10 may or may not comprise heating. According to various example embodiment said press unit 10 may be a heated press unit 10 for heating said cellulose blank 7 during pressing. In the case of a heated press unit 10, preheating of said cellulose blank 7 using a pre-heating unit 11 is optional. According to various example embodiments preheating of the cellulose blank 7 in said pre-heating unit 11 may be combined with a heated press unit 10. Having a pre-heating unit 11 in combination with a heated press unit 10 will speed up the manufacturing process in the product forming unit 8, and improve the quality/rigidity of the final rigid cellulose product 2. In the product forming unit 8 the cellulose blank 7 is heated to a temperature in the range 120-200° C. in order to obtain adequate rigidity and strength in the final cellulose product 2.

Reference is now especially made to FIGS. 2 and 3. FIG. 2 disclose a first type of cellulose blank 7 comprising one cellulose blank segment, constituted by a first cellulose blank segment 12a or a second cellulose blank segment 12b. The cellulose blank segment 12a, 12b comprises at least one product area 13a, 13b and a rim area 14a, 14b located adjacent and at least partly surrounding the at least one product area 13a, 13b. Outside the rim area 14a, 14b the cellulose blank segment 12a, 12b may comprise a scrap/residual area 15. FIG. 3 disclose another type of cellulose blank 7 comprising two cellulose blank segments, constituted by a first cellulose blank segment 12a and a second cellulose blank segment 12b. The first cellulose blank segment 12a comprises at least one product area 13a and a rim area 14a located adjacent and at least partly surrounding the at least one product area 13a, and the second cellulose blank segment 12b comprises at least one product area 13b and a rim area 14b located adjacent and at least partly surrounding the at least one product area 13b. Outside the rim areas 14a, 14b the cellulose blank 7 may comprise a scrap/residual area 15.

It shall be pointed out that the cellulose blank 7 according to FIG. 2 having one product area 13a, 13b may comprise a plurality of product areas 13a, 13b, and the first cellulose blank segment 12a and the second cellulose blank segment 12b according to FIG. 3 having a plurality of product areas 13a, 13b may comprise only one product area 13a, 13b each.

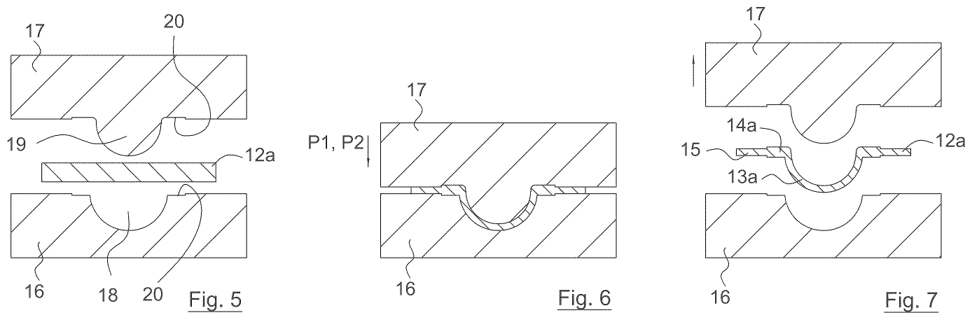

Reference is now made to FIGS. 5-7. The press unit 10 comprises a first moulding tool having a first mould part 16 and a second mould part 17, wherein at least one of the first mould part 16 and the second mould part 17 is/are displaceable back and forth in relation to each other, in order to exert pressure to the cellulose blank 7 loaded therebetween. In the figures the mutual displacement is disclosed as being vertical, however the mutual displacement may be horizontal or any other suitable angle. The cellulose blank 7 loaded into the first moulding tool, is constituted by an air-laid first cellulose blank segment 12a. The air-laid first cellulose blank segment 12a may be generated/manufactured upstream the product forming unit 8 in the same production line and provided to the product forming unit 8, or may be generated/manufactured at a separate location and provided to the product forming unit 8 via intermediate handling and storage.

According to various embodiments the first mould part 16 of the first moulding tool is a female mould part, i.e. having a recess 18 for receiving the product area 13a of the first cellulose blank segment 12a, and the second mould part 17 of the first moulding tool is a male mould part, i.e. having a protrusion 19 for cooperation with said recess 18, such that the product area 13a of the first cellulose blank segment 12a is pressed into a final rigid non-flat shape therebetween.

During the pressing, disclosed in FIG. 6, a predetermined first pressure P1 is applied by the first moulding tool between the recess 18 and the protrusion 19. Thus, the product area 13a of the first cellulose blank segment 12a thereby obtains its final rigid non-flat shape, which may have any conceivable non-flat design/shape.

During the pressing of the product area 13a of the first cellulose blank segment 12a in the first moulding tool, the rim area 14a of the first cellulose blank segment 12a is kept in a non-final non-rigid shape, i.e. the first mould part 16 and/or the second mould part 17 comprise(s) grooves 20 adjacent the recess 18 and/or the projection 19. Such grooves 20 in the mould parts entails that the mutual distance between the surfaces of the first mould part 16 and the second mould part 17 at the product area 13a is less than the mutual distance between the surfaces of the first mould part 16 and the second mould part 17 at the rim area 14a, whereby the rim area 14a is un-compressed or only partially compressed when the product area 13a is pressed. The mutual distance at the rim area 14a is preferably equal to or more than 20% greater than the mutual distance at the product area 13a, and preferably equal to or less than 100% greater than the mutual distance at the product area 13a. Thereby the rim area 14a remains un-compressed or is only partially compressed, in the first moulding tool, i.e. kept in a non-final non-rigid shape when the product area 13a of the first cellulose blank segment 12a is pressed. When the rim area 14a of the first cellulose blank segment 12a is partially compressed into a non-final non-rigid shape, it is performed by applying a predetermined third pressure P3, wherein P3<P1. At the scrap area 15 the mutual distance between the first mould part 16 and the second mould part 17 is equal to or more than the mutual distance at the product area 13a. The scrap area 15 may be left entirely uncompressed, be partially compressed by applying for instance the predetermined third pressure P3 or be fully compressed by applying the predetermined first pressure P1.

In FIG. 7 the first cellulose blank segment 12a is released by opening the first moulding tool, wherein the product area 13a is pressed into final rigid non-flat shape and the rim area 14a is kept in a non-final non-rigid shape.

Regarding the second cellulose blank segment 12b the invention comprises various embodiments, but common for all embodiments is that a second cellulose blank segment 12b is loaded into a second moulding tool that is part of the press unit 10. It shall be pointed out that the second moulding tool does not need to be arranged at the same location as the first moulding tool. It shall also be pointed out that the second moulding tool may be constituted by the first moulding tool, or by a moulding tool of the same type/design as said first moulding tool.

The second cellulose blank segment 12b, like the air-laid first cellulose blank segment 12a, comprises at least one product area 13b and a rim area 14b located adjacent and at least partly surrounding the at least one product area 13b. During the pressing, the at least one product area 13b of the second cellulose blank segment 12b is pressed into a final rigid shape by applying a predetermined second pressure P2. The predetermined second pressure P2 is preferably equal to the predetermined first pressure P1.

According to various embodiments, during the pressing, the rim area 14b of the second cellulose blank segment 12b is kept/maintained in a non-final non-rigid shape, or the rim area 14b of the second cellulose blank segment 12b is pressed into a rigid shape by applying the predetermined second pressure P2. The scrap area 15 may be left entirely uncompressed, be partially compressed or be fully compressed by applying the predetermined second pressure P2. According to various embodiments the second moulding tool is identical to, or is constituted by, the first moulding tool. Thereby, the same steps are preformed in order to generate the second cellulose blank segment 12b having pressed product area 13b as described above to generate the first cellulose blank segment 12a having pressed product area 13a. In such embodiments the rim area 14b of the second cellulose blank segment 12b is kept/maintained in a non-final non-rigid shape, and the second cellulose blank segment 12b is constituted by an air-laid second cellulose blank segment 12b. Thus at least one product area 13b of the second cellulose blank segment 12b is pressed into a final rigid non-flat shape by applying the predetermined second pressure P2.

According to various embodiments the second moulding tool is different than the first moulding tool. The second moulding tool comprises a first mould part and a second mould part, wherein at least one of the first mould part and the second mould part is/are displaceable back and forth in relation to each other, in order to exert pressure to the cellulose blank 7 loaded therebetween. The mutual displacement may be vertical, however the mutual displacement may be horizontal or any other suitable angle. The cellulose blank 7 loaded into the second moulding tool, may be an air-laid second cellulose blank segment 12b.

According to various embodiments the first mould part of the second moulding tool is a female mould part, i.e. having a recess for receiving the product area 13b of the second cellulose blank segment 12b, and the second mould part of the second moulding tool is a male mould part, i.e. having a protrusion for cooperation with said recess, such that the product area 13b of the second cellulose blank segment 12b is pressed into a final rigid non-flat shape therebetween.

Alternatively the first mould part and the second mould part of the second moulding tool, may both have a flat/plane shape at the location receiving the product area 13b of the second cellulose blank segment 12b. According to various alternatives of these embodiments, the first mould part and/or the second mould part of the second moulding tool may have grooves adjacent the locations receiving the product area 13b of the second cellulose blank segment 12b, i.e. at the location receiving the rim area 14b of the second cellulose blank segment 12b. Thereby, the rim area 14b of the second cellulose blank segment 12b is kept/maintained in a non-final non-rigid shape. When the rim area 14b of the second cellulose blank segment 12b is partially compressed into a non-final non-rigid shape, it is performed by applying a predetermined fourth pressure P4, wherein P4<P2. According to some other various alternatives of these embodiments, the first mould part and the second mould part of the second moulding tool does not have any grooves adjacent the locations receiving the product area 13b of the second cellulose blank segment 12b, i.e. at the location receiving the rim area 14b of the second cellulose blank segment 12b. Thereby, the rim area 14b of the second cellulose blank segment 12b is pressed into a rigid shape by applying the predetermined second pressure P2.

According to various embodiments the second cellulose blank segment 12b is made of cardboard/paperboard, i.e. the second cellulose blank segment 12b is pressed in a second moulding tool that may be located off-site from the rest of the production line 1. Such second moulding tool presses both the product area 13b and the rim area 14b of the second cellulose blank segment 12b into a final rigid shape using the predetermined second pressure P2.

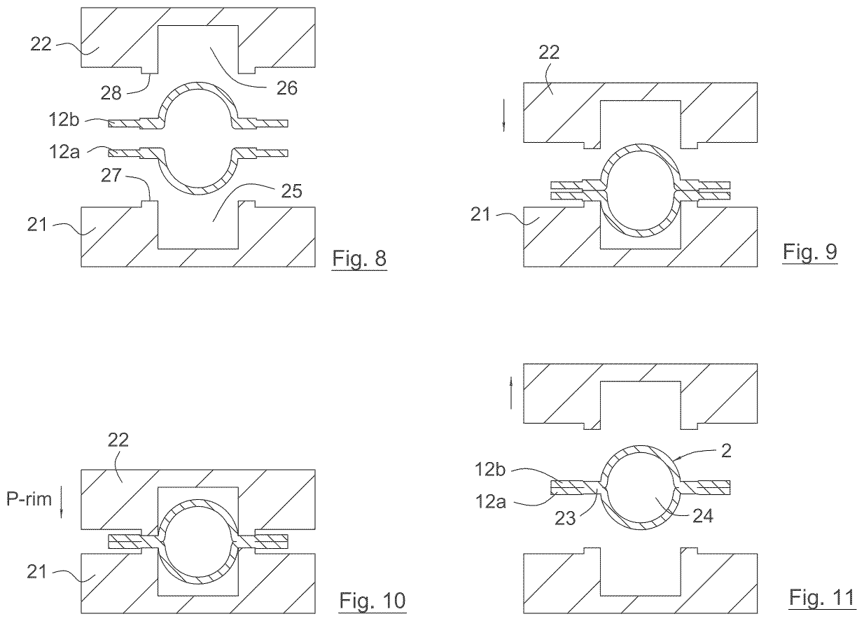

Reference is now made to FIGS. 8-11, disclosing the joining/bonding of the rigid cellulose product 2, which is made after/downstream the first and second moulding tools. FIGS. 8-11 disclose a third moulding tool having a first mould part 21 and a second mould part 22, wherein the third moulding tool is part of the pressing unit 10. The third moulding tool is configured to join together the rim area 14a of the first cellulose blank segment 12a and the rim area 14b of the second cellulose blank segment 12b into a final rigid rim 23 by applying a predetermined rim pressure P-rim, thereby obtaining the rigid cellulose product 2 having non-flat general shape and an internal cavity 24. The predetermined rim pressure P-rim is preferably greater than the predetermined first pressure P1.

The first mould part 21 of the third moulding tool comprises a recess 25 configured to receive the pressed product area 13a of the first cellulose blank segment 12a, more precisely the first mould part 21 of the third moulding tool, at the location of the product area 13a of the first cellulose blank segment 12a, has a shape entailing that the first mould part 21 does not abut/contact the already pressed product area 13a having final rigid non-flat shape.

The second mould part 22 of the third moulding tool comprises a recess 26 configured to receive the pressed product area 13b of the second cellulose blank segment 12b, more precisely the second mould part 22 of the third moulding tool, at the location of the product area 13b of the second cellulose blank segment 12b, has a shape entailing that the second mould part 22 does not abut/contact the already pressed product area 13b having final rigid shape, flat or non-flat shape.

In FIG. 8 the first cellulose blank segment 12a having pre-pressed product area 13a and the second cellulose blank segment 12b having pre-pressed product area 13b are introduced/loaded into the third moulding tool. In FIG. 9, the rim area 14a of the first cellulose blank segment 12a is placed in contact with the rim area 14b of the second cellulose blank segment 12b, and the at least one pre-pressed product area 13a of the first cellulose blank segment 12a is placed in overlapping configuration with the at least one pre-pressed product area 13b of the second cellulose blank segment 12b. The rim area 14a of the first cellulose blank segment 12a is placed on a rim surface 27 of the first mould part 21, and the rim area 14b of the second cellulose blank segment 12b is in contact with a rim surface 28 of the second mould part 22. The rim surface 27 of the first mould part 21 and the rim surface 28 of the second mould part 22 correspond in shape and location to the rim area 14a of the first cellulose blank segment 12a and of the rim area 14b of the second cellulose blank segment 12b. According to various embodiments, the rim surface 27 of the first mould part 21 and/or the rim surface 28 of the second mould part 22 are arranged on a protruding collar. The protruding collars entails that the scrap/residual area 15 of the blank segments 7 are not compressed further and thereby easier to recycle. Thus, the rim area 14a of the first cellulose blank segment 12a is placed on the rim surface 27 of the first mould part 21 of the third moulding tool and thereafter the second cellulose blank segment 12b is placed on the first cellulose blank segment 12a, or the first and second cellulose blank segments are placed onto each before introduced into the third moulding tool. Thus, the first cellulose blank segment 12a and the second cellulose blank segment 12b are separated from each other and constitutes two discrete cellulose blanks 7 that are loaded into the third moulding tool.

According to various embodiments, before the step of placing the rim area 14a of the first cellulose blank segment 12a in contact with the rim area 14b of the second cellulose blank segment 12b, a liquid composition comprising cellulose or starch may be applied to at least one of the rim area 14a of the first cellulose blank segment 12a and the rim area 14b of the second cellulose blank segment 12b. The liquid composition is preferably constituted by cellulose fibres that are wetted/dampened by water. Alternatively, only water is applied to at least one of the rim area 14a of the first cellulose blank segment 12a and the rim area 14b of the second cellulose blank segment 12b.

In FIG. 10, the rim area 14a of the first cellulose blank segment 12a and the rim area 14b of the second cellulose blank segment 12b are joined/bonded together into the final rigid rim 23 by applying the predetermined rim pressure P-rim, thereby obtaining the rigid cellulose product 2 having non-flat general shape wherein the internal cavity 24 is delimited by the pre-pressed product area 13a of the first cellulose blank segment 12a and by the pre-pressed product area 13b of the second cellulose blank segment 12b.

The mutual distance between the rim surface 27 of the first mould part 21 and the rim surface 28 of the second mould part 22 during the joining/bonding of the final rigid rim 23, is less than the total thickness of the pressed product area 13a of the first cellulose blank segment 12a and the pressed product area 13b of the second cellulose blank segment 12b. During the joining/bonding of the final rigid rim 23 it becomes homogenous. By homogeneous means that the rim has uniform material characteristics/properties throughout the entire rim, i.e. the interface between the rim area 14a of the first cellulose blank segment 12a and the rim area 14b of the second cellulose blank segment 12b cannot be identified after joining of the homogenous final rigid rim 23. Thus, the rigid rim 23 has no weakening at the location of the previous interface between the rim area 14a of the first cellulose blank segment 12a and the rim area 14b of the second cellulose blank segment 12b.

In FIG. 11 the joined/bonded rigid cellulose product 2 having non-flat general shape and an internal cavity 24 is released by opening the third moulding tool.

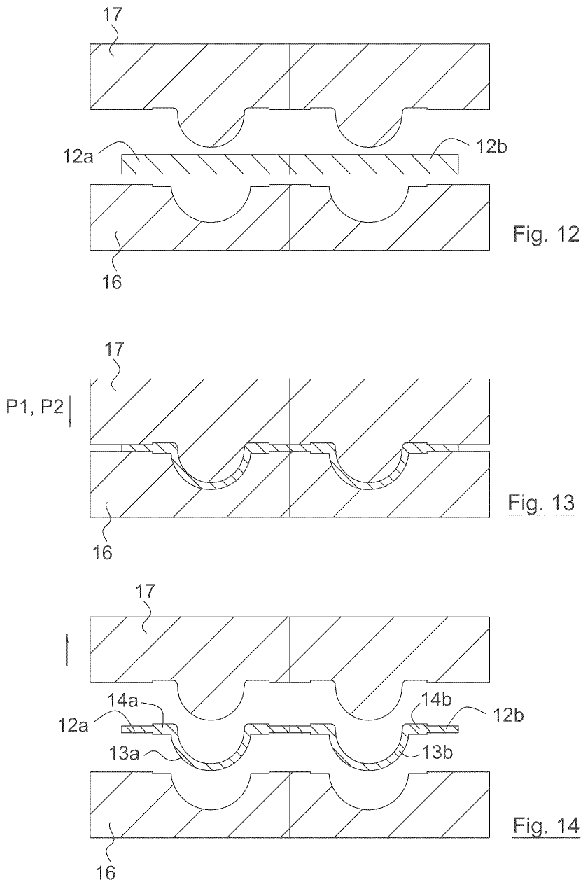

Reference is now made to FIGS. 12-14 disclosing a combination of a first moulding tool and a second moulding tool that are configured to cooperate, i.e. joint displacement. A cellulose blank 7 according to FIG. 3, i.e. having a first cellulose blank segment 12a and a second cellulose blank segment 12b, is inserted/loaded into the combined first/second moulding tool according to FIG. 12. Everything described herein above concerning the functions and structures of the first moulding tool and the second moulding tool is applicable. The cellulose blank 7 is constituted by an air-laid cellulose blank 7. According to FIG. 13 the product area 13a of the first cellulose blank segment 12a and the product area 13b of the second cellulose blank segment 12b are pressed into final rigid shape, wherein at least the rim area 14a of the first cellulose blank segment 12a is kept/maintained in non-final non-rigid shape, and preferably also the rim area 14b of the second cellulose blank segment 12b is kept/maintained in non-final non-rigid shape. According to FIG. 14 the cellulose blank 7 comprising a first cellulose blank segment 12a having a pressed product area 13a and a second cellulose blank segment 12b having a pressed product area 13b is released by opening the combined first/second moulding tool.

Reference is now made to FIG. 15 disclosing the third moulding tool according to FIGS. 8-11. The cellulose blank 7 comprising a first cellulose blank segment 12a having a pressed product area 13a and a second cellulose blank segment 12b having a pressed product area 13b is folded such that the rim area 14a of the first cellulose blank segment 12a abut/contact the rim area 14b of the second cellulose blank segment 12b, and the pre-pressed product area 13a of the first cellulose blank segment 12a is placed in overlapping configuration with the pre-pressed product area 13b of the second cellulose blank segment 12b. The cellulose blank 7 may be provided with a notch/perforation between the first cellulose blank segment 12a and the second cellulose blank segment 12b, in order to facilitate correct folding of the cellulose blank 7 before loading into the third moulding tool. The joining/bonding of the final rigid rim 23 is performed as described herein above in connection with FIG. 10. Thus, the first cellulose blank segment 12a and the second cellulose blank segment 12b are connected to each other and constitutes one single cellulose blank 7 that is loaded into the third moulding tool.

Reference is now made to FIGS. 16-19, disclosing the cross-section of different rigid cellulose products 2 manufactured using the inventive method, in order to disclose examples embodiments. In connection with the step of joining/bonding the final rigid rim 23, the final rigid rim 23 of the rigid cellulose product 2 is preferably trimmed. The rigid cellulose products 2 disclosed in FIGS. 16-19 are trimmed, i.e. at least the scrap area 15 is removed.

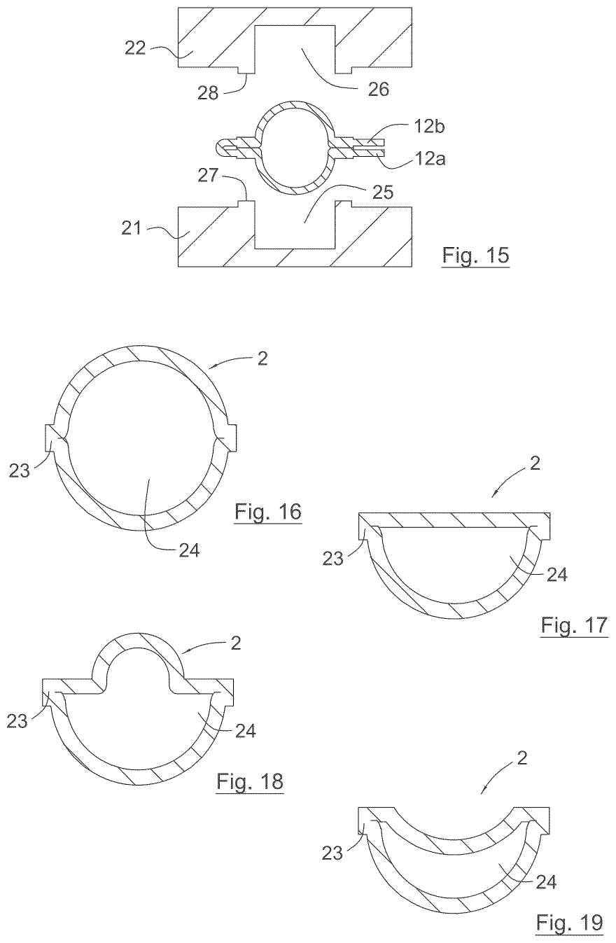

In FIG. 16 the two halves of the rigid cellulose product 2 have the same shape. In FIG. 17 the upper half of the rigid cellulose product 2 is flat and the lower half has non-flat shape, and may for instance be constituted by a second cellulose blank segment 12b made from cardboard/paperboard. In FIG. 18 the two halves of the rigid cellulose product 2 have different non-flat shape, but both have a generally convex shape towards the outside. In FIG. 19 the two halves of the rigid cellulose product 2 have different non-flat shape, but the product area 13a of the first cellulose blank segment 12a has a generally convex shape towards the outside and the product area 13b of the second cellulose blank segment 12b has a generally concave shape towards the outside.

The rigid cellulose products illustrated in FIGS. 16-19 may be roto-symmetrical about a vertical axis or may have oblong shape extending into to paper.

According to various embodiments the rim area 14a of the first cellulose blank segment 12a is circumferential and surrounds the at least one product area 13a of the first cellulose blank segment 12a, and the rim area 14b of the second cellulose blank segment 12b is circumferential and surrounds said at least one product area 13b of the second cellulose blank segment 12b, whereby the final rigid rim 23 of the rigid cellulose products 2 is circumferential.

According to various embodiments, the final rigid rim 23 may comprises a plurality of spots or short lines distributed along the interface between the rim area 14a of the first cellulose blank segment 12a and the rim area 14b of the second cellulose blank segment 12b of the rigid cellulose product 2.

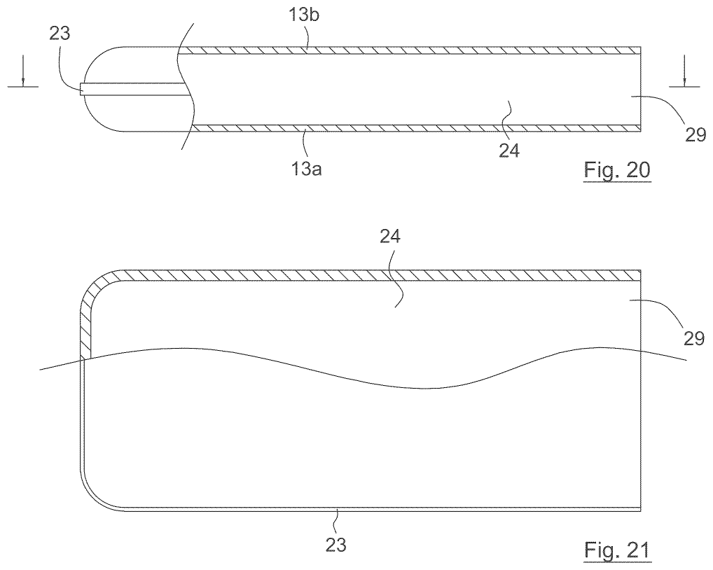

Reference is now made to FIGS. 20-21, disclosing an example embodiment of a so called “deep-drawn” rigid cellulose product 2, i.e. the depth of the rigid cellulose product 2 is much deeper than the diameter of the opening of the rigid cellulose product 2. The disclosed rigid cellulose product 2 may be used as a protective pouch for a mobile-phone, reading glasses, or the like. The internal cavity 24 of the rigid cellulose product 2 is open to the outside. Thus, the final rigid rim 23 is not circumferential, and the rigid cellulose product 2 comprises an opening 29. The cross-sectional area of the opening 29 may be greater than, equal to, or less than an off-set cross-sectional area of the internal cavity 24.

According to various embodiments the final rigid rim 23 is circumferential and the opening 29 is located in one of the product area 13a of the first cellulose blank segment 12a and the product area 13b of the second cellulose blank segment 12b. According to various embodiments, the opening 29 may be provided with a cap, lid, or the like.

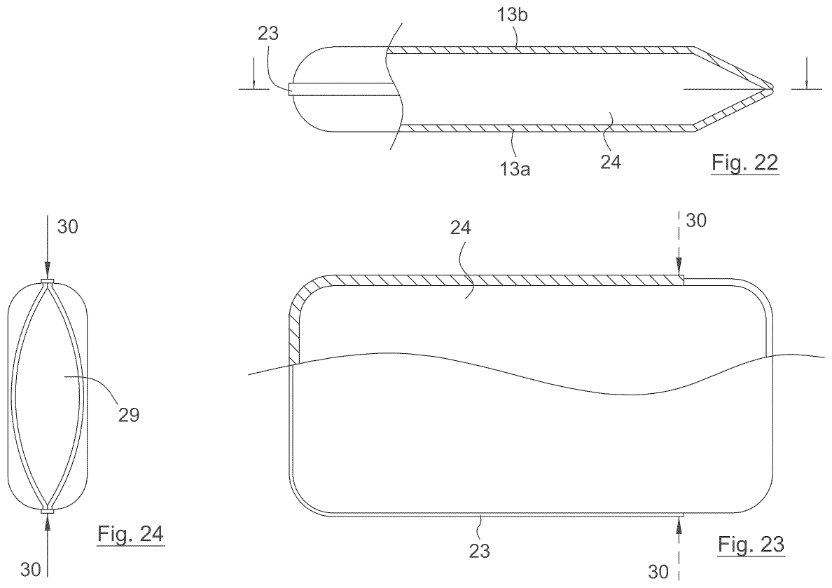

Reference is now made to FIGS. 22-24, disclosing an alternative to FIGS. 20-21, wherein the internal cavity 24 of the rigid cellulose product 2 is openable/closable to the outside. Thus, the final rigid rim 23 is not circumferential, and the rigid cellulose product 2 comprises an opening 29 that is closed in the unaffected state, see FIG. 22 disclosing a cross-sectional side view of the rigid cellulose product 2. In FIG. 23 disclosing a view from above, wherein half of the rigid cellulose product 2 is disclosed in cross-section, and in FIG. 24, arrows 30 are included to demonstrate an applied force, whereby the opening 29 is opened as is illustrated in FIG. 24 disclosing an end view of the rigid cellulose product 2 in an open state.

The predetermined pressures P1, P2 and P-rim is in the range 40-10000 N/cm², preferably in the range 100-4000 N/cm². According to various embodiments said predetermined pressures are above 1000 N/cm² , and according to various embodiments said predetermined pressures are below 2500 N/cm² . The holding time during the different pressing steps is in equal to or more than 1 second and equal to or less than 10 seconds, preferably less than 5 seconds, and most preferably less than 3 seconds.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

It shall be pointed out that the final rigid cellulose product may be constituted by three or more segments, wherein each pair of neighbouring segments are joined/connected to each other according to the present invention.

1. method for dry manufacturing rigid cellulose products having non-flat general shape and an internal cavity, the method comprising the steps of:
providing an air-laid first cellulose blank segment, wherein the first cellulose blank segment comprises at least one product area and a rim area located adjacent and at least partly surrounding said at least one product area,
pressing the at least one product area of the first cellulose blank segment into a final rigid non-flat shape by applying a predetermined first pressure P1;
keeping the rim area of the first cellulose blank segment in a non-final non-rigid shape,
providing a second cellulose blank segment wherein the second cellulose blank segment comprises at least one product area and a rim area located adjacent and at least partly surrounding the at least one product area of the second cellulose blank segment,
pressing the at least one product area of the second cellulose blank segment into a final rigid shape by applying a predetermined second pressure P2,
thereafter
placing the rim area of the first cellulose blank segment in contact with the rim area of the second cellulose blank segment, and placing the at least one product area of the first cellulose blank segment in overlapping configuration with the at least one product area of the second cellulose blank segment, and
joining together the rim area of the first cellulose blank segment and the rim area of the second cellulose blank segment into a homogenous final rigid rim by applying a predetermined rim pressure P-rim, thereby obtaining the rigid cellulose product having non-flat general shape wherein the internal cavity is delimited by the pressed product area of the first cellulose blank segment and by the pressed product area of the second cellulose blank segment

2. The method according to claim 1, wherein the step of:
pressing the at least one product area of the second cellulose blank segment into a final rigid shape by applying a predetermined second pressureP2, further comprises the step of:
keeping the rim area of the second cellulose blank segment in a non-final non-rigid shape, or
pressing the rim area of the second cellulose blank segment into a rigid shape by applying the predetermined second pressureP2.

3. The method according to claim 1, wherein the second cellulose blank segment is constituted by an air-laid second cellulose blank segment.

4. The method according to claim 1, wherein the at least one product area of the second cellulose blank segment is pressed into a final rigid non-flat shape by applying the predetermined second pressureP2.

5. The method according to claim 1, wherein the step of:
keeping the rim area of the first cellulose blank segment in a non-final non-rigid shape,
comprises the step of:
partially compressing the rim area of the first cellulose blank segment into a non-final non-rigid shape by applying a predetermined third pressureP3, wherein P3<P1.

6. The method according to claim 2, wherein the step of:
keeping the rim area of the second cellulose blank segment in a non-final non-rigid shape, comprises the step of:
partially compressing the rim area of the second cellulose blank segment (12b) into a non-final non-rigid shape by applying a predetermined forth pressureP4, wherein P4<P2.

7. The method according to claim 1, wherein the rim pressure P-rim>P1.

8. The method according to claim 1, wherein the rim area of the first cellulose blank segment is circumferential and surrounds said at least one product area of the first cellulose blank segment, and the rim area of the second cellulose blank segment is circumferential and surrounds said at least one product area of the second cellulose blank segment, whereby the homogenous final rigid rim of the rigid cellulose products having non-flat general shape is circumferential.

9. The method according to claim 1, wherein the step of:
joining together the rim area (14a) of the first cellulose blank segment and the rim area of the second cellulose blank segment into the homogenous final rigid rim by applying a predetermined rim pressure P-rim, comprises the step of:
trimming the homogenous final rigid rim of the rigid cellulose products having non-flat general shape.

10. The method according to claim 1, wherein prior to the step of:
placing the rim area of the first cellulose blank segment in contact with the rim area of the second cellulose blank segment, the method further comprises the step of:
applying a liquid composition comprising cellulose to at least one of the rim area of the first cellulose blank segment or the rim area of the second cellulose blank segment

11. The method according to claim 1, wherein said first cellulose blank segment and said second cellulose blank segment are:
connected to each other and constitutes one single cellulose blank, or
separated from each other and constitutes two discrete cellulose blanks.

12. An apparatus for dry manufacturing rigid cellulose products having essentially non-flat general shape and an internal cavity from an air-laid first cellulose blank segment and a second cellulose blank segment wherein the first cellulose blank segment comprises at least one product area and a rim area located adjacent and at least partly surrounding said at least one product area of the first cellulose blank segment, and wherein the second cellulose blank segment comprises at least one product area and a rim area located adjacent and at least partly surrounding the at least one product area of the second cellulose blank segment, the apparatus comprising:
a first moulding tool having a first mould part and a second mould part configured to press the at least one product area of the first cellulose blank segment into a final rigid non-flat shape by applying a predetermined first pressure P1, and to keep the rim area of the first cellulose blank segment in a non-final non-rigid shape,
a second moulding tool having a first mould part and a second mould part configured to press the at least one product area of the second cellulose blank segment into a final rigid shape by applying a predetermined second pressure P2, and
a third moulding tool located downstream and having a first mould part and a second mould part configured to join together the rim area of the first cellulose blank segment and the rim area of the second cellulose blank segment into a homogenous final rigid rim by applying a predetermined rim pressure P-rim, thereby obtaining the rigid cellulose product having non-flat general shape and an internal cavity.

13. A rigid cellulose product having essentially non-flat general shape, manufactured by the method according to claim 1, wherein the rigid cellulose product has an internal cavity delimited by a pressed product area of a first cellulose blank segment and by a pressed product area of the second cellulose blank segment, wherein a rim area of the first cellulose blank segment that is located adjacent and at least partly surrounds said product area of the first cellulose blank segment, and a rim area of the second cellulose blank segment that is located adjacent and at least partly surrounds said product area of the second cellulose blank segment are joined at a homogeneous final rigid rim.

14. The rigid cellulose product according to claim 13, wherein the rigid cellulose product comprises cellulose fibres from a cellulose raw material constituted by virgin cellulose fibres and/or recycled cellulose fibres, wherein the cellulose fibres originate from wood pulps such as kraft pulp, sulphite pulp, mechanical pulp, thermomechanical pulp, chemical treated mechanical pulp, chemi-thermomechanical pulp, and/or from non-wood pulps such as bagasse, bamboo, abaca, hemp, flax, cotton.

15. The rigid cellulose product according to claim 13, wherein the rim area of the first cellulose blank segment is circumferential and surrounds said at least one product area of the first cellulose blank segment, and the rim area of the second cellulose blank segment is circumferential and surrounds said at least one product area of the second cellulose blank segment, whereby the homogenous final rigid rim of the rigid cellulose products having non-flat general shape is circumferential.

16. The rigid cellulose product of claim 13, wherein said first cellulose blank segment and said second cellulose blank segment are connected to each other and constitutes one single cellulose blank.

17. The rigid cellulose product of claim 13, wherein said first cellulose blank segment and said second cellulose blank segment are separated from each other and constitutes two discrete cellulose blanks.

18. The rigid cellulose product of claim 13, wherein the rigid cellulose product further comprises an opening configured to provide external access to the internal cavity.

19. The rigid cellulose product according to claim 18, wherein the opening comprises a cross-sectional area that is equal to or greater than an off-set cross-sectional area of the internal cavity.

20. The rigid cellulose product according to claim 18, wherein the opening comprises a cross-sectional area that is equal to or less than an off-set cross-sectional area of the internal cavity.
